(19) United States
(12) Patent Application Publication
(10) Pub. No.: US 2007/0083425 A1
(43) Pub. Date: Apr. 12, 2007

(54) Distributed system enabling integration and automation of marketing, sales and service

(76) Inventors: John Glen Cousineau, Vancouver (CA); Chris Goard, Vancouver (CA); Eric Hawthorne, Burnaby (CA); Jackie Ho, Richmond (CA); Travis Hildebrandt, Vancouver (CA); Luca Fillipozzi, North Vancouver (CA); Michael Johnson, Vancouver (CA); Ivar Vasara, Vancouver (CA); Felix Kan, Tsing Yi (HK)

Correspondence Address: BRANDON N. SKLAR. ESQ. (PATENT PROSECUTION);KAYE SCHOLER, LLP, 425 PARK AVENUE, NEW YORK, NY, 10022-3598, US

(21) Appl. No.: 10/541,620

(22) PCT Filed: Jan. 9, 2004
(86) PCT No.: PCT/CA04/00041

§ 371 Date: Nov. 17, 2006

Related U.S. Application Data
(60) Provisional application No. 60/438,588, filed on Jan. 9, 2003.

(51) Int. Cl. G07G 1/14; G06Q 30/00

(52) U.S. Cl. 705/14

(57) ABSTRACT

The present invention provides a distributed electronic management system enabling the creation, distribution and tracking of at least one electronic message to at least one predetermined potential customer, said system comprising: a data storage system for organizing and storing a plurality of content, selected portions of said content for insertion into the at least one electronic message; a production system for the creation of the at least one electronic message, said at least one electronic message having a predetermined theme, wherein content having the predetermined theme can be inserted into the at least one electronic message; a messaging system performing functions including transmission of the at least one electronic message to the at least one predetermined potential customer, said messaging system and the at least one predetermined customer being interconnected by at least one communication network; a tracking system for collecting and evaluating notifications based on interaction with the at least one electronic message by the at least one predetermined potential customer; wherein the data storage system, production system, messaging system and tracking system are electronically interconnected thereby enabling electronic information transfer therebetween.

### RESERVATION OF COPYRIGHT

A portion of the disclosure of this patent document contains material to which a claim of copyright protection is made. The owner has no objection to the facsimile reproduction by anyone of the patent document or the patent disclosure as it appears in the Patent and Trademark Office patent file or records, but reserves all other rights whatsoever.

### FIELD OF THE INVENTION

The present invention pertains to business systems and in particular to a distributed system enabling integration of a plurality of marketing, sales and customer-service functions of a business.

### BACKGROUND

On-going communication between a business and its customers and partners is an integral part of any business relationship. With recent advances in technology, the Internet, and information and applications delivered via the Internet, have become a central part of business-to-customer and business-to-business communications and transactions. Important technological advances that have made this possible include, the availability of increased bandwidth and advanced data compression techniques, emerging communication standards and protocols, and improved searching and indexing technologies. In addition, the Internet is a highly proximate medium, allowing marketing information to be brought closer to customers, both physically and in terms of time.

Traditionally, management of customer relationships was generally based on orchestrating the sequence and content of phone-based interactions with customers. Information about the general condition and interest of a phone prospect or contact was provided, without providing any specifics of the customer relationship. The burden on content production was minimal and hidden from the customer's view. With electronic customer relationship management, the content production burden is much greater, and the content directly faces the customer. The process must orchestrate the sequence and substance of on-line content in ways that ensure pertinence and harness attention, under constantly changing customer and content viewing conditions.

In a recent study, approximately 70% of marketing executives said they continue to have trouble capturing the attention of customers and approximately 65% are struggling to integrate and share customer data across the organization. The challenge, therefore, is to speed the location, production, organization and distribution of content that gets the attention of customers. The opportunity is quickly emerging to do so, in a variety of formats using component-based, standards-enabled, abstractions of content. Furthermore, the Aberdeen Group notes that future innovation will be in enhanced offerings, such as the production and distribution of rich media.

Such challenges have led to the emergence of precision e-marketing techniques. This allows targeting of customers with the right offer at the right time. Traceable results allow accountability to management and optimization of offers over time. Precision e-marketing is delivering approximately five-fold increases in response rates with conversion costs only approximately one-tenth those of direct mail.

U.S. Pat. No. 6,567,786 discloses a system and method for increasing the effectiveness of customer contact strategies. Rather than focusing on an individual promotion event and determining which customers, based on historical data, meet a certain ROI criteria and excluding those who do not meet the criteria, this system and method focuses on a particular customer or customer group (called a class), and their ROI value with respect to an entire set of promotion events proposed to be implemental over a period of time. An analysis is made of the impact of saturation and the “cannibalization” effect saturation may have on promotion events occurring before or after a particular promotion start date, or even occurring at the same time. Customers are analyzed based upon historical criteria; a promotional plan (a group of promotion events implemented or to be implemented over a particular time period) is analyzed to determine the effect of each promotion event on the other promotion events in the promotional plan; and based on this analysis, the optimal promotion stream (a specific subset of the promotional plan to be sent to customers or a group of similar customers) is determined so as to maximize the ROI of the promotional plan as a whole.

Furthermore, an information and advertising distribution system is disclosed in U.S. Pat. No. 5,740,549. A data server stores and updates a database of information items and advertisements. The information items and advertisements are each; categorized so that each has an associated information category. Workstations remotely located from the data server each include a display device, a communication interface for receiving at least a subset of the information items and advertisements in the data server's database and local memory for storing the information items and advertisements received from the data server. An information administrator in each workstation establishes communication with the data server from time to time so as to update the information items and advertisements stored in local memory with at least a subset of the information items and advertisements stored by the data server. An information display controller in each workstation displays on the workstation's display device at least a subset of the information items and advertisements stored in local memory when the workstation meets predefined idleness criteria. At least a subset of the workstations include a profiler for storing subscriber profile data. The subscriber profile data represents subscriber information viewing preferences, indicating information categories for which the subscriber does and does not want to view information items. The information display controller includes a filter for excluding from the information items displayed on the display device those information items inconsistent with the subscriber profile data.

In addition, U.S. Pat. No. 5,717,923 discloses a method and apparatus for dynamically customizing electronic information to individual users. This method and apparatus includes a client system containing a personal profile database which stores consumer information corresponding to individual end user(s) of the client system. The client system also includes a content adapter which compares electronic information received by the client system to the consumer information in the personal profile database and customizes the electronic information to an individual end user based on this comparison. The client system also includes a client activity monitor which monitors actions taken by an individual end user when consuming electronic information and updates the personal profile database based on these actions. The client activity monitor can also monitor which actions are ignored by the individual end user and updates the personal profile database based on the consumer's interaction with the electronic information (that is both the consumer's action and inaction). An electronic information server containing a plurality of electronic information units can be coupled to the client system via an electronic information distribution network and serves as the source of the electronic information.

However, due to the increase in digitization of data, valuable information is increasingly buried in a haystack of digitized content. Storing the world's total production of content would require approximately 250 megabytes per year per person for each man, woman, and child on earth. By 2047, the vast majority of all information collected about physical objects, including humans, buildings, processes, and organizations, will likely be online. This meals that a smaller and smaller fraction of all information produced is actually consumed. There is therefore a need to cut through emerging forms of content clutter that inhibits business process effectiveness. Subsequently, there is a need to ensure that content sent to customers is relevant and harnesses attention.

The large amount of information available on the Internet further leads to the challenge of avoiding wasted marketing, sales and customer-service communication effort. Thus, there is a need to measure the reach and impact of content produced and distributed. Therefore there is a need for a system enabling integration and automation of marketing, sales and service.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a distributed system enabling integration and automation of marketing, sales and service. In accordance with an aspect of the present invention, there is provided a distributed electronic customer relationship management system enabling the creation, distribution and tracking of at least one electronic message to at least one predetermined potential customer, said system comprising: a data storage system for organizing and storing a plurality of content, selected portions of said content for insertion into the at least one electronic message; a production system for the creation of the at least one electronic message, said at least one electronic message having a predetermined theme, wherein content having the predetermined theme can be inserted into the at least one electronic message; a messaging system performing functions including transmission of the at least one electronic message to the at least one predetermined potential customer, said messaging system and the at least one predetermined customer being interconnected by at least one communication network; a tracking system for collecting and evaluating notifications based on interaction with the at least one electronic message by the at least one predetermined potential customer; wherein the data storage system, production system, messaging system and tracking system arc electronically interconnected thereby enabling electronic information transfer therebetween.

In accordance with another aspect of the invention, there is provided a method for the creation, distribution and tracking of at least one electronic message to at least one predetermined potential customer, said method comprising the steps of: organizing and storing a plurality of content, selected portions of said content for insertion into the at least one electronic message; creating the at least one electronic message, said at least one electronic message having a predetermined theme, wherein content having the predetermined theme can be inserted into the at least one electronic message; transmitting the it least one electronic message to the at least one predetermined potential customer; collecting and evaluating notifications based on interaction with the at least one electronic message by the at least one predetermined potential customer; wherein the collection and evaluation of the notifications enables incorporation of content relating to these previous notifications into a subsequently created and transmitted electronic message to the same predetermined potential customer.

In accordance with another aspect of the invention, there is provided a computer program product comprising a computer readable medium having a computer program recorded thereon for performing a method for the creation, distribution and tracking of at least one electronic message to at least one predetermined potential customer comprising the steps of: organizing and storing a plurality of content, selected portions of said content for insertion into the at least one electronic message; creating the at least one electronic message, said at least one electronic message having a predetermined theme, wherein content having the predetermined theme can be inserted into the at least one electronic message; transmitting the at least one electronic message to the at least one predetermined potential customer; collecting and evaluating notifications based on interaction with the at least one electronic message by the at least one predetermined potential customer; wherein the collection and evaluation of the notifications enables incorporation of content relating to these previous notifications into a subsequently created and transmitted electronic message to the same predetermined potential customer.

### BRIEF DESCRIPTION OF THE FIGURES

FIG. 1 is a screenshot of components of one embodiment of the present invention, and a high level view of how each relates to the other.

FIG. 2 is a high level view of one embodiment of the present invention.

FIG. 3 illustrates components of the system according to one embodiment of the present invention.

FIG. 4 is a data flow diagram according to the embodiment illustrated in FIG. 3.

FIG. 5 is a content sharing, categorizing and rating system according to one embodiment of the present invention.

FIG. 6 is a screenshot of a user interface for entering an image into a content sharing, categorizing and rating system according to one embodiment of the present invention.

FIG. 7 is a screenshot of a user interface for searching content and browsing search results in a content sharing, categorizing and rating system according to one embodiment of the present invention.

FIG. 8 is a screenshot of a user interface for inspecting and rating a multimedia presentation found in a content sharing, categorizing and rating system according to one embodiment of the present invention.

FIG. 9 is a multimedia message production system data flow diagram according to one embodiment of the present invention.

FIG. 10 is a screenshot of a user interface for creating a multimedia template having a semantic-outline mark-up according to one embodiment of the present invention.

FIG. 11 is a screenshot of a user interface for creating a customized multimedia presentation by substituting content items into a multimedia template according to one embodiment of the present invention.

FIG. 12 is a screenshot of a user interface for substituting an image from a library for an image that occurs in a multimedia template according to one embodiment of the present invention.

FIG. 13 is a screenshot of a user interface for authoring a rich-media electronic message with traceable hyperlinks according to one embodiment of the present invention.

FIG. 14 is a screenshot of a user interface for previewing a rich-media electronic message during authoring according to one embodiment of the present invention.

FIG. 15 is a screenshot of a user interface for choosing customer records to be added to an “audience type” category according to one embodiment of the present invention.

FIG. 16 is a screenshot of a user interface for completing the addition of customer records to an “audience-type” category according to one embodiment of the present invention.

FIG. 17 is a screenshot of a user interface for message audience targeting based on a logical combination of audience-types and content interaction history according to one embodiment of the present invention.

FIG. 18 is a conceptual view of a data transfer system according to one embodiment of the present invention.

FIG. 19 is a data replication system according to one embodiment of the present invention.

FIG. 20 is a data replication system sequence diagram according to one embodiment of the present invention.

FIG. 21 is a bulk messaging system according to one embodiment of the present invention.

FIG. 22 is a bulk messaging system sequence diagram according to one embodiment of the present invention.

FIG. 23 is a screenshot of a user interface for viewing aggregate statistics of customer interaction with message-linked content according to one embodiment of the present invention.

FIG. 24 is a screenshot of a user interface for viewing details of customer interaction with message-linked content according to one embodiment of the present invention.

FIG. 25 is a screenshot of a user interface for viewing an individual customer's history of interaction with message-linked content according to one embodiment of the present invention.

FIG. 26 is an example of a customer conversion rate graphing technique, showing speed of transactions by audience-type according to one embodiment of the present invention.

FIG. 27 is a screenshot of health and performance monitoring system user interface according to one embodiment of the present invention.

### DETAILED DESCRIPTION OF THE INVENTION

Definitions

The term “electronic message” is used to define any message created or transmitted in electronic format including an electronic letter, electronic newsletter, electronic postcard, cellular telephone text message, pager message, email, or any other such message.

The term “content” is used to define images, text, hypertext, documents, hyperdocuments, multimedia productions, motion pictures, audio tracks or any other medium of information.

The term “interaction point” is used to define a means for one to interact with an electronic message. An interaction point can be a link, hyperlink or other means as would be readily understood by a worker skilled in the art.

The term “content element” is used to define components into which a multimedia data file or other information electronic file can be broken down.

The term “multimedia template” is used to define a conjunction of a multimedia data file and its semantic outline in XML, or other format as would be readily understood by a worker skilled in the art.

The term “semantic outline” is used to define a collection of content elements labelled with meaningful names.

The term “message-sending company” is used to define a company that wishes to send information to potential customers.

The term “audience-type category” is used to define the identification of a group of customer records categorized with respect to a common interest or other criteria of the customers.

The term “messaging controller site” is used to define the site that initiates and coordinates the sending of messages to the individual customers via the message-sending company.

Unless defined otherwise, all technical and scientific terms used herein have the same meaning as commonly understood by one of ordinary skill in the art to which this invention belongs.

The present invention provides a distributed system that allows organizations to quickly collect and distribute information to their customers electronically and to monitor the interaction of their customers in response to the information sent. The system integrates and automates some of the marketing, sales and customer-service functions of an organization. The present invention can provide a means for the production, delivery and analysis and planning of customer communications employed in marketing research, sales and customer-service processes. This can speed the Return On Investment (ROI) from business processes and may lower the cost of operating these processes.

The system can be implemented as an addition to existing legacy systems and business processes via its Enterprise Application Integration (EAI) middleware. It can be deployed as a component-based, distributed web service that is architected to enable companies using the system to deploy the specific combination of components needed to address their needs.

Electronic message production occurs via web-enabled production systems that create templates from existing content, and enable users to quickly customize, personalize, re-purpose, publish and deliver content, in specific formats, to a customer or group of customers. Targeting of personal and bulk communications delivered by the system is informed by on-going diagnoses of the ‘state of mind’ of a customer, that can be based on transactions and interactions in real time (both via legacy systems, and via content viewing, transactions, and interactions provoked by the content delivered by the present invention, for example). Analytics can monitor the impact of content delivered on target outcomes. The present invention can enable the entire process to be operated and managed, as an on-going ‘conversation’ with each customer that is iteratively shaped by customer responses to preceding content.

The present invention embodies strategic, tactical, and functional patterns which, when embodied in a network-enabled application, can make it possible for individual users to get their information, knowledge-based and relationship engendering work done more efficiently and more effectively with the assistance of valued colleagues, partners, customers and prospective new customers. The present invention can enable the delivery of the right information to the right people at the right time in ways that get their attention, and provoke them into self-serviced interactions and transactions that speed discoveries and sales.

The invention enables users to quickly create and maintain their own digital library of valuable on-line content and contacts. It can enable them to virally build their library with the sell-serviced, non-obtrusive and non-disruptive assistance of colleagues. It can also enable them to rate the value of specific information items that they, or their colleagues, have contributed. Their ratings, over time, can enable patterns of valuable content and valuable relationships internal to an organization to emerge. Important information can then be sent to colleagues, customers or prospects quickly by electronic means in the form of an electronic message. These recipients can be targeted based on their prior self-serviced transactions, interactions and content viewing behaviours. In addition, the present invention provides a means for the tracking of the attention obtained from the recipients. For example, all embedded hyperlinks that point to further details in an electronic message are automatically personalized, to enable tracking of recipient click-actions. These click actions can yield data that record the types of topics of interest, as well as (if the necessary component is invoked, at the user's discretion) yield additional diagnostic data on the electronic message formats that each customer is able to view. The content viewing activities of individual customers can thus be tracked thereby providing a means for information on activities spawned by individual campaigns and the content viewing impacts on specified transactions (for example, sales) of those customers and campaigns.

In one embodiment, a multimedia component of the present invention can enable the customization of multimedia content using appropriate content production tools, factories and templates presented in a web browser user interface. The resulting productions can be automatically published to the Internet as new URLs, for example, and available for embedding into any outbound distillation of content in any of several electronic message formats (for example, a briefing, newsletter or an announcement). In addition, existing multimedia content can also be parsed from their Internet browser, thereby adding new templates to the electronic message production systems according to the present invention.

In one embodiment, the system provides a means for monitoring the performance of the distributed network infrastructure, on which the system of the present invention is operating, and can automatically receive notifications via messaging systems, for example email or SMS whenever critical performance thresholds are crossed.

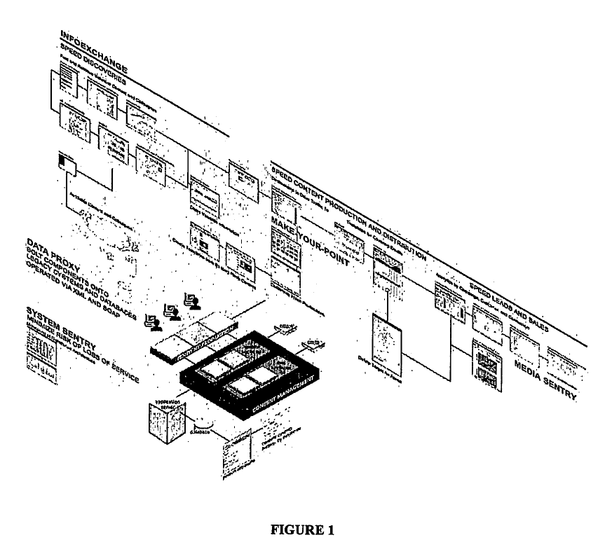

FIG. 1 illustrates a screenshot of components of the system according to one embodiment of the present invention together with a high level view of how each relates to the other.

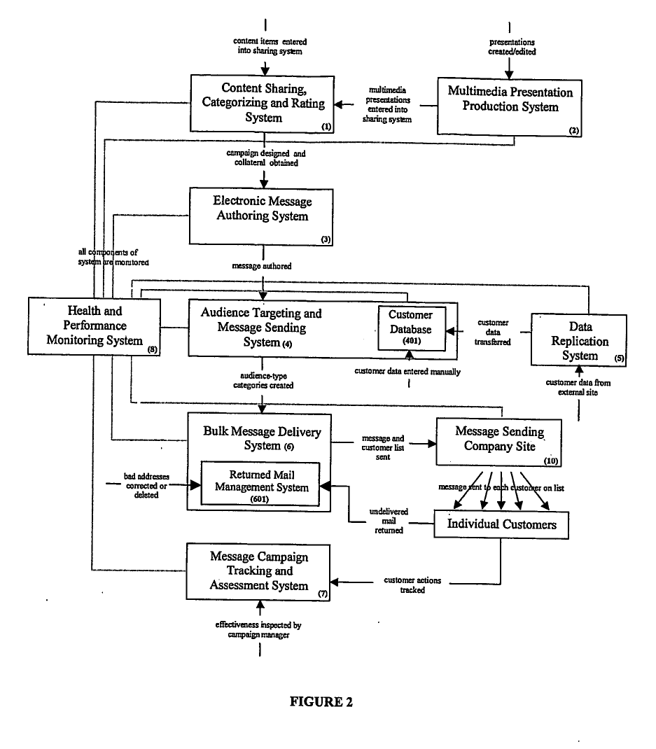

FIG. 2 illustrates a high level view of one embodiment of the distributed system. The distributed system according to the present invention can be categorized into eight main components for purposes of description, however the components may be inter-related and any number of these components can be combined together to form individual modules. These components are: (i) an information sharing, categorizing and rating system (1), (ii) a multimedia message production and editing system (2), (iii) a rich-content electronic message and electronic newsletter authoring system (3), (iv) an audience targeting and message sending system (4), (v) a data replication system (5) that transfers data between remote locations, for example, between the organization that composes the messages, henceforth referred to as the messaging controller site, and organizations that provide information such as customer contact lists, (vi) a bulk message delivery system (6) between the messaging controller site and the organization that wishes to send the messages to its individual customers, henceforth, referred to as the message-sending company (10), including a returned mail management system (601), (vii) a tracking system (7) that monitors interactions initiated by the customers as a result of receiving one or more of the electronic messages sent to them, and (viii) a system (8) that monitors the health and performance of the entire distributed system.

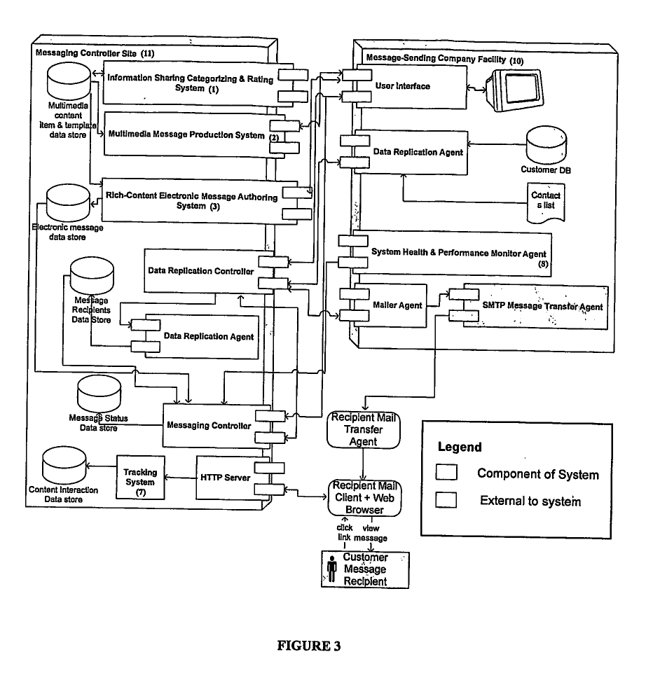

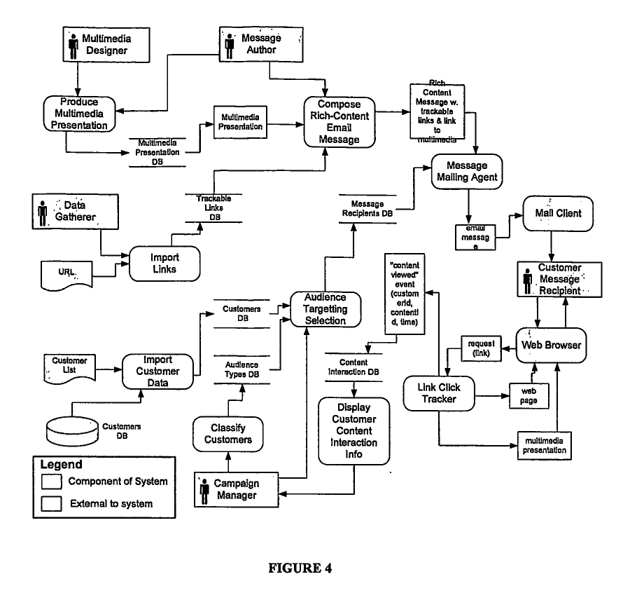

FIG. 3 illustrates one embodiment of the present invention and FIG. 4 illustrates a data flow diagram for the embodiment illustrated in FIG. 3.

Information pertaining to a company's business, products, or services is entered into the content sharing, categorizing and rating system (1). This content can include for example images, documents, hyperdocuments, multimedia productions and any other type of content as would be readily understood by a worker skilled in the art. A customer communication campaign can then be designed, including suggestions as to the overall message to be sent, the feedback needed from the customers, and possibly which customers should receive which variations of the message. The message author then searches the content sharing system (1) for appropriate content to be used in the message. The author may, at this stage, can also edit any multimedia components using informatiaon from the content sharing system (1) including text, images, links, audio tracks, and motion pictures, using the multimedia system (2).

The rich-content electronic message authoring system (3) can subsequently be used to create an electronic message with appropriate links to the content items located during the search of the content sharing system (1). These content items can include a multimedia presentation or other web-accessible documents. The message author may also include a hyperlink to the company website where the recipient of the message is allowed to perform a self-service business transaction with the company. The campaign manager then uses the audience targeting system (4) to create several audience-type categories to group various records of customers with similar interests. The customer records are stored in a customer database (401) and can be entered manually into the database or imported into the database using the data replication system (5). The text and links or interaction points, for example a hyperlink, in each message for a particular group of customers can then be appropriately edited to allow tracing and electronically sent to the message-sending company server using the bulk messaging system (6). In addition, in one embodiment any electronic message that is not delivered to the customer as a result of an invalid address can be reported by the returned mail management system (601). The campaign manager can inspect this returned mail management system (601) and correct the electronic address if required, or can delete this address if the message was returned due to a confirmed invalid address.

Periodically over the time following the sending of the electronic messages, the campaign manager can inspect the campaign effectiveness statistics and graphs presented by the tracking system (7). The campaign manager can use this tool to analyze which customers clicked on which message link or interaction point and when this action occurred. In addition the tracking system can analyze the speed of engaging customers in the desired business transaction with the company. The campaign manager may therefore be provided with information about customer behaviour, customer preferences, and may determine which customers should receive further communication. This can also provide the campaign manager with an idea of the type of content to be incorporated into this further communication for these identified customers. Based on the insights about customer behaviour and preferences that can be obtained from the tracking system (7), the campaign manager can design further electronic messages and possibly further multimedia presentations, and send them in due course, as described above, to appropriately targeted customers. This system, in combination with the audience targeting system, can also be able to automatically categorize customers into further audience-type categories, based on which interaction points, of the electronic message were clicked on by the electronic message recipients or customers and when.

Each component of the distributed system of the invention is described in more detail below based on one embodiment of the present invention.

Content Sharing, Categorizing and Rating System (1)

The content sharing, categorizing and rating system provides a means for the users of the system according to the present invention to provide information relating to the content inserted into the system thereby enabling other users or themselves to identify useful content in a more effective manner.

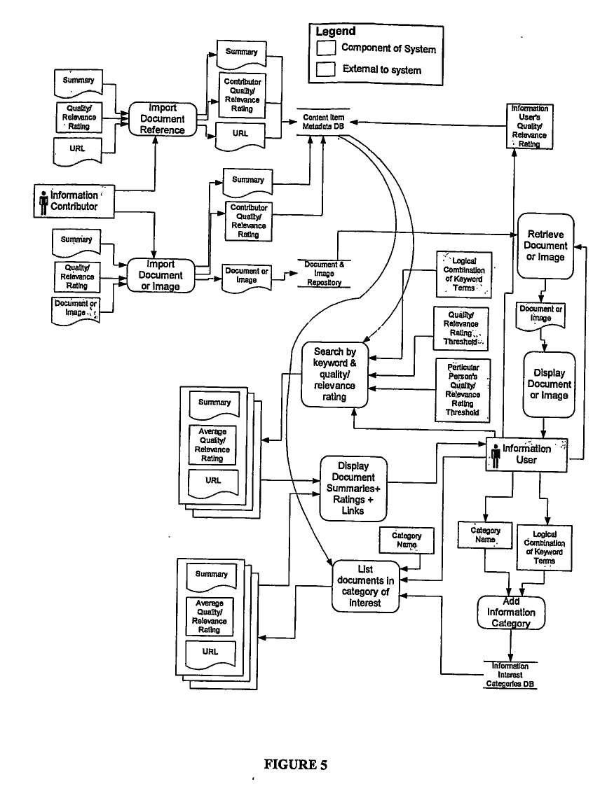

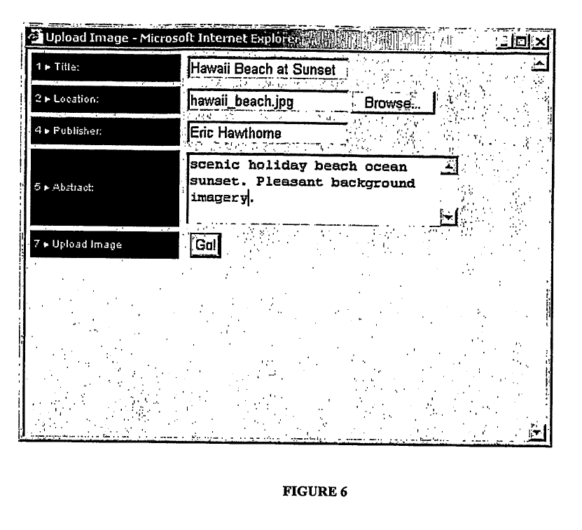

The flow of data through this system is illustrated in FIG. 5. This system can allow a user to enter a universal resource locator (URL) reference or other form of tag to a document, hyperdocuments, image, or multimedia content item, or text from a text or hypertext document into it data entry form. The user interface for entering an image is shown in FIG. 6. The user can also enter descriptive keywords and a summary of the content item into the form as well as choose from a range of “usefulness/quality” values to categorize the item.

The user can establish a user profile within the system and can include keywords of interest to them. When the user views the main content item listing screen, they are presented, without an explicit request, with a list of recently entered items whose keywords or summaries match their keywords.

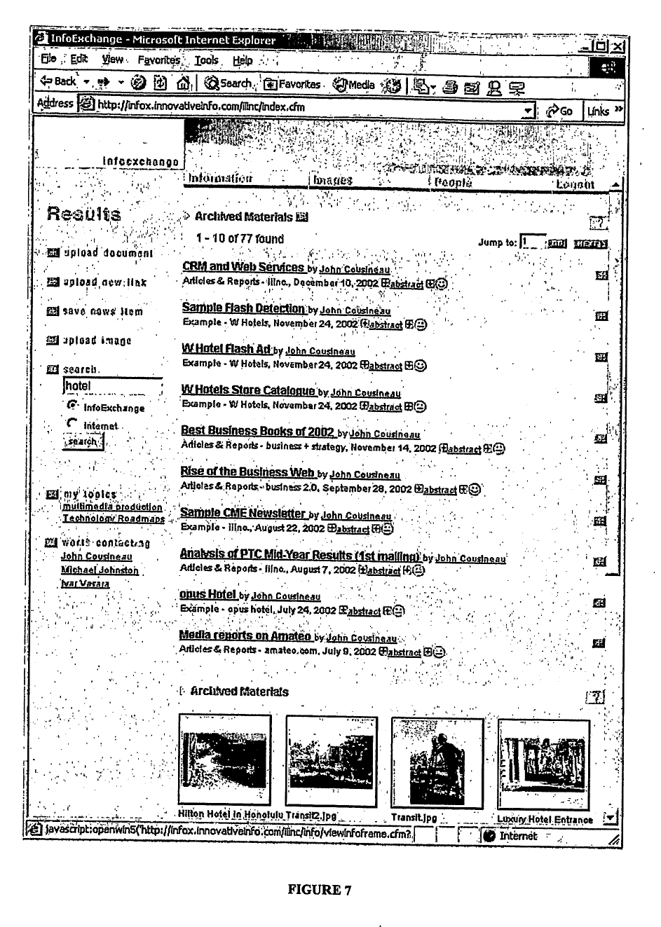

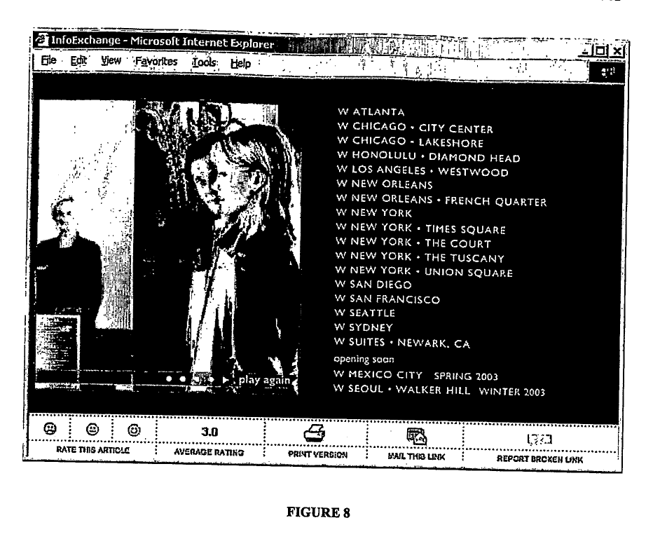

The user may also enter keywords and logical expressions to search and view lists of items within the system. The user interface for searching the system is shown in FIG. 7. The selected item is displayed in the appropriate viewer software (e.g. a web browser window, or web browser window containing a Portable Document Format viewer plug-in) and surrounded by buttons for example that are part of the system as shown in FIG. 8. The buttons can allow the user to rate the usefulness/quality of the item, and to forward the content to other users via electronic, messages. The system tracks, in a database, which users have viewed, rated, and forwarded which content items. Users can also filter their search results by specifying content quality/usefulness thresholds, or by retrieving only items that have been viewed or deemed worthwhile by particular other users.

Two-Stage Multimedia Presentation Production System (2)

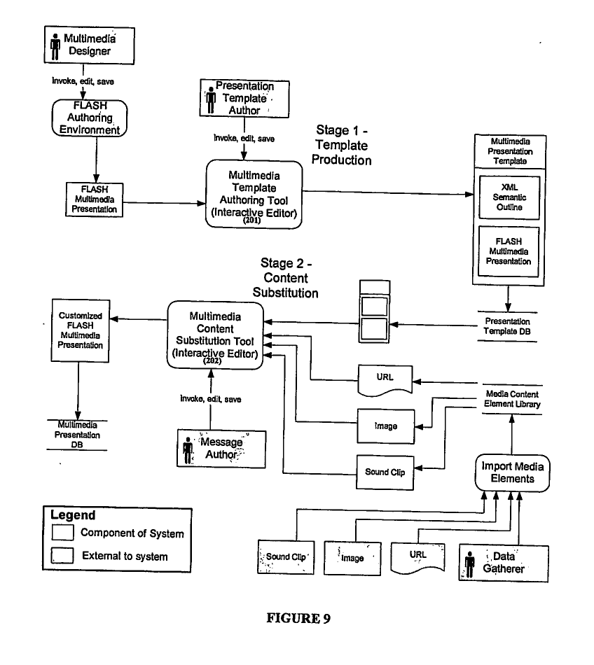

Data flow through this system is shown in FIG. 9. The first stage (201) of the multimedia system (2) comprises a component used to create a multimedia presentation template, and the second stage (202) comprises a component used to edit a semantically annotated multimedia presentation template to produce a particular multimedia message, presentation or story suited to a particular purpose. The information sharing, categorizing and rating system (1) shares its database with the multimedia presentation production system and content items from the former can be used to add or replace items in the latter.

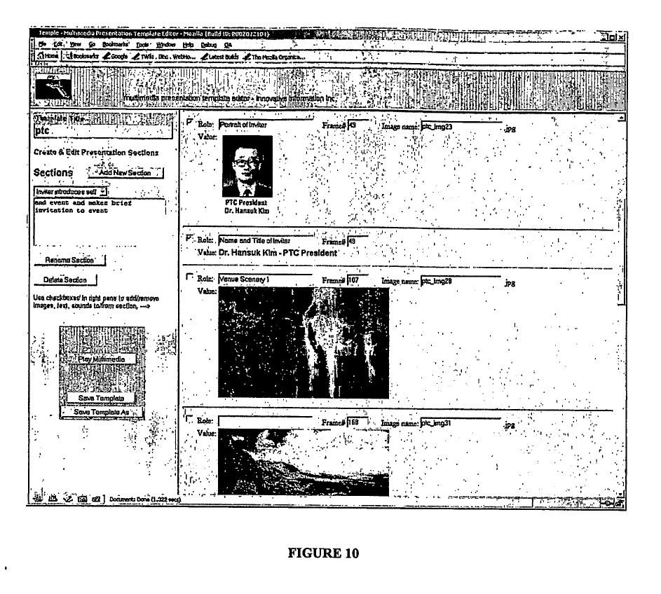

In the first stage (201), a user is able to import a multimedia data file (for example, but not limited to, a Macromedia FLASH movie) into the system. The system reads the sequence of multimedia content tags and commands that comprise the multimedia data file, and decomposes the multimedia data file into constituent simple content elements, including but not limited to text elements, sound elements, image elements, and URL linked text and button elements. The system presents a user interface that allows the user to view and label individual content elements of the multimedia, with meaningful names, and to collect the elements into named logical sections in a “semantic outline” of the multimedia as shown in FIG. 10. This semantic outline can be stored in XML, or similar format as would be readily understood. The conjunction of the original multimedia data file and the XML outline becomes a multimedia template, with clearly identified replaceable individual content items.

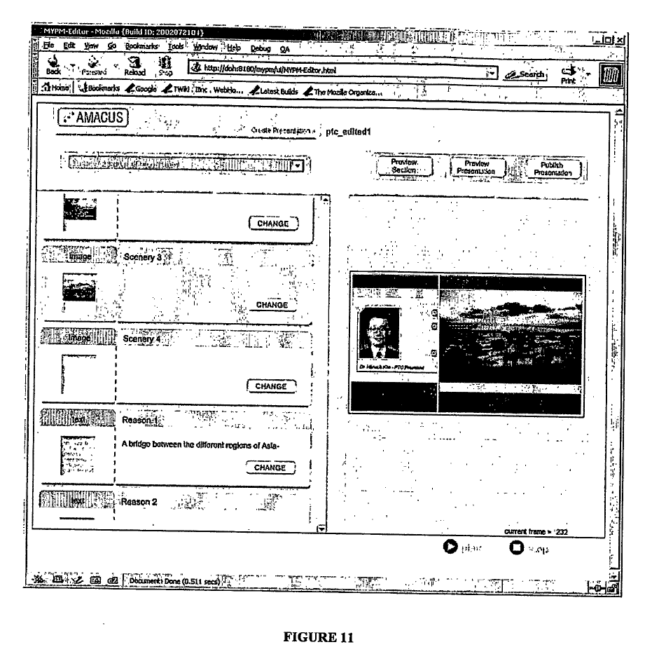

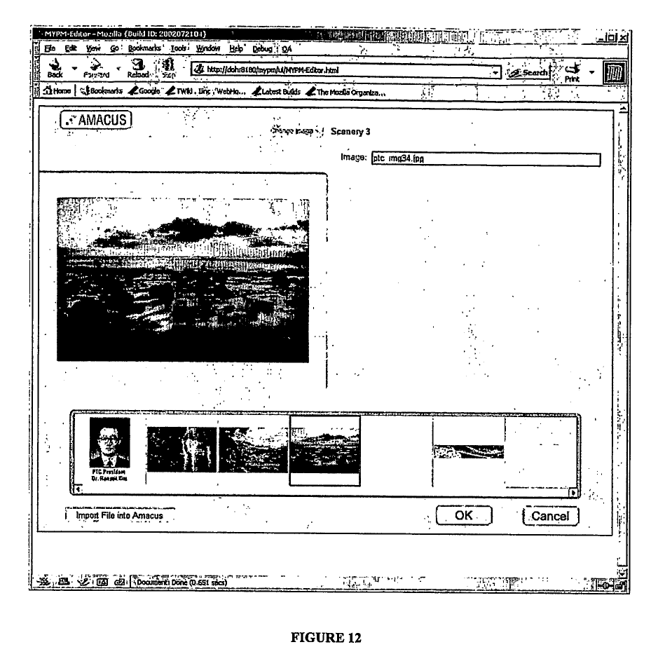

In the second stage (202), a second user interface, as shown in FIG. 11, is subsequently presented which displays or runs the multimedia, alongside a list of the semantically labelled replaceable content elements. Selecting a content element from the list automatically causes the display of the multimedia to show the scene of the multimedia that contains that selected content element. The user is subsequently able to select a “change” button that is associated with the content element in the list. A user interface as shown in FIG. 12, is presented in which an alternative media content item can be selected to replace the selected content item. The system creates and immediately displays a new version of the multimedia data file, which incorporates the replacement content item instead of the original content item.

The alternative media content items, for use in content replacement, can be authored directly by the user in the user interface (in the case of text or URL link or button items), or chosen by the user from a palette of items which the system retrieves from the content sharing system (1) and displays in the content item editing user interface.

Rich-Content Electronic Message Authoring System (3)

This is also a two-part system, wherein the first component enables the rapid and convenient creation of standardized electronic newsletters, and the second a component enables rapid and convenient creation of rich-content electronic messages. As in the case of the multimedia system, the sharing, categorizing and rating system (1) database is also shared with the rich-content electronic message authoring system (3) and content items from the former can be inserted into electronic messages created in the latter.

In the first component, the user is presented with a user interface comprising an editable template of a newsletter. The template can have clearly denoted fields for entry of the newsletter section name, the paragraph header and the paragraph text content of a single newsletter paragraph. The template user interface can also have a multilingual text language selector, which allows selection of the language in which the paragraph is to be authored. The template user interface can also allow the selection of a linkable document or hyperdocument, and the creation of link anchor text, so that a single link can be included in the newsletter at the end of each paragraph.

When the user has filled in the content, the template user-interface can present the electronic newsletter as it would appear to the recipients of the newsletter. The user may then edit the content further, delete a paragraph, or add and edit further paragraphs. A form is also provided in the user interface to allow for the authoring and editing of signature information, such as organization name and contact information, for placement at the end of the newsletter for example.

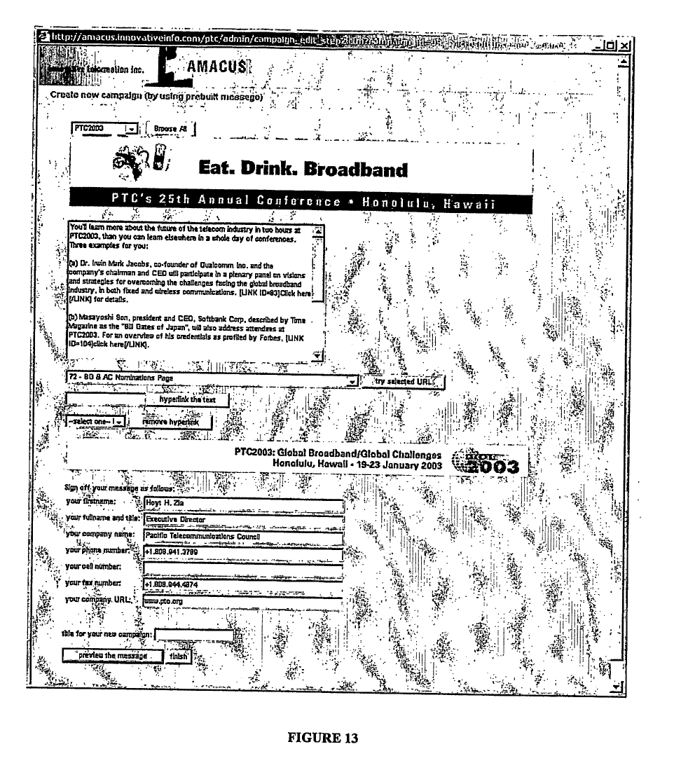

In the second component, the user is presented with a user interface comnprising an editable template of an electronic message. The template has a clearly denoted field for entry of the electronic message body text as shown in FIG. 13. The user interface allows a section of the text to be designated a link anchor. The user interface can also allow the selection of a linkable document or hyperdocument, and the insertion of a hyperlink to the linkable item into the electronic message body at the position of the anchor text. In addition, the user interlace presents a selection of header and footer image pairs, and allows the user to choose a pair of images to be displayed as a header and footer decoration of the electronic message body, for example.

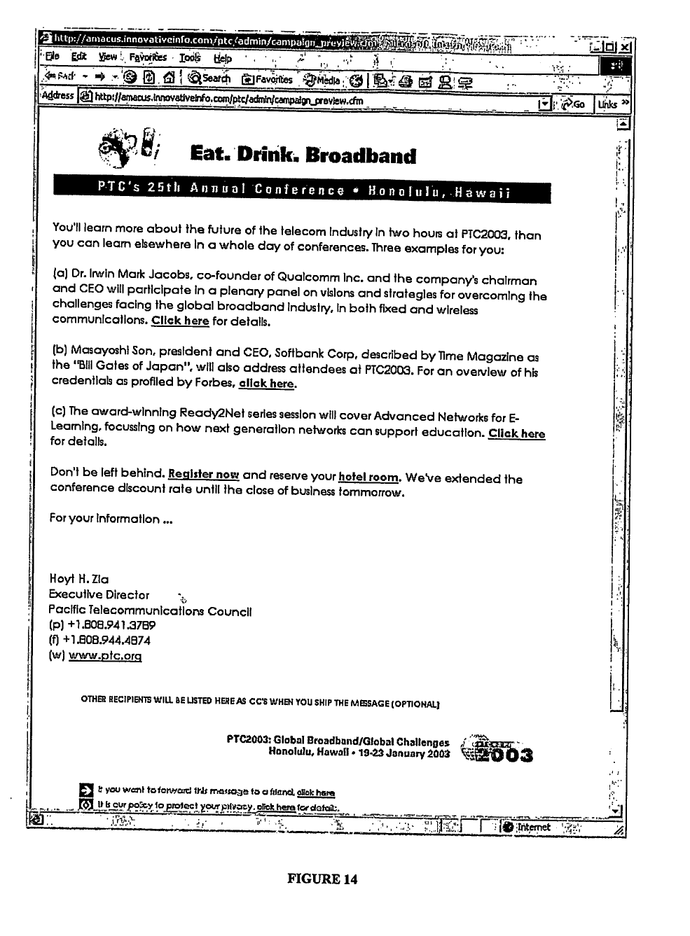

When the user has filled in the electronic message content, the template user-interface can present the electronic message as it would appear to the recipients of the electronic message as shown in FIG. 14. The user may then edit the electronic message further if desired, or save the electronic message and exit the electronic message authoring user interface.

Audience Targeting and Message Sending System (4)

As previously mentioned, this system includes a customer database (401) that the user can configure bulk-loading, of customer records to, on a one-time basis, or on a periodically executed basis, from external customer databases, using the data replication system (5) described below. The user can, optionally for example, type in a recipient's name and electronic mail address information, and the system will insert that information in the customer database (401).

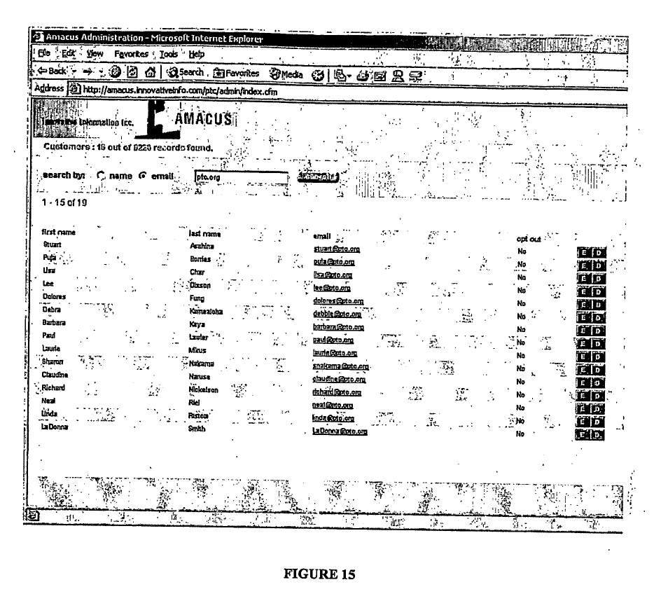

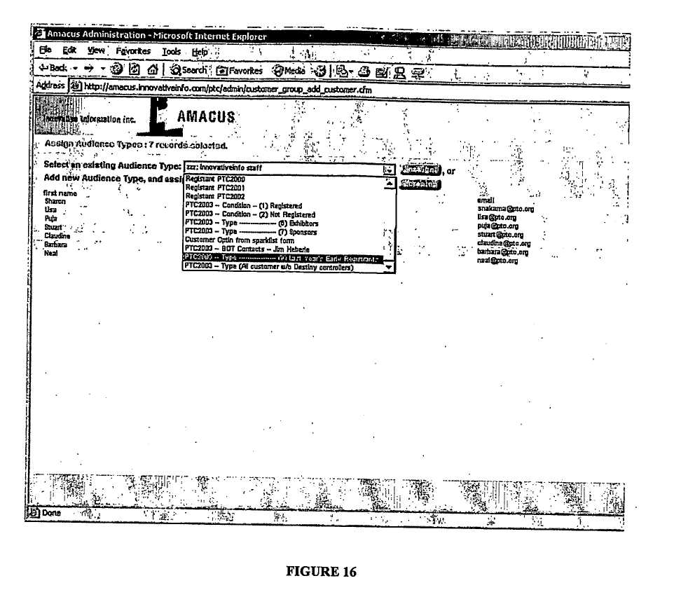

Within this system the user can create audience-types, each being a named set of customer records. The user may provide search criteria as shown in FIG. 15, to obtain lists of customers that can then be categorized into these audience-types as shown in FIG. 16. As mentioned previously, customers can also be automatically categorized into audience-types based on information obtained from the tracking system (7) based on customer interaction with a previously transmitted electronic message.

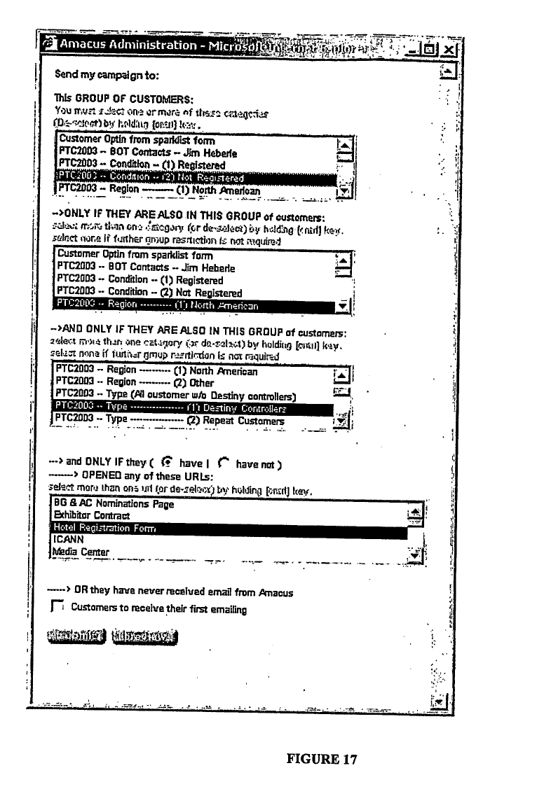

In addition, the user can specify the list of recipients for a particular electronic message. This can be done by entering search keywords and the system can return matching customer records, which the user may then manually select individually and add to the electronic message recipients list. The user can also specify a logical expression of audience-types to obtain a list of electronic message recipients as shown in FIG. 17. The user may restrict the electronic message recipients list to those customers who have or have not received particular electronic messages sent out in the past by the system or message recipients who have or have not clicked on particular interaction points in content sent out in the past by the system, by adding this restriction to the logical expression.

The system can also have a configurable time period wherein any customer that has received a electronic message within a predetermined time period will be excluded automatically from the recipients list for the current electronic message. The purpose of this feature is to avoid the delivery of multiple unsolicited electronic messages to the same customer within a short period of time. This feature can be particularly useful if a single customer record is categorized under several logical message audience-types, and separate but similar electronic messages are specified to be sent to each of those audience-types all whithin a short time period.

The send the electronic message, the user specifies the electronic message, the recipient list as described above, a subject text line, and the sender and reply-to names and an electronic address, for example an electronic mail address. The system displays the number of recipients and provides an opportunity to preview the electronic message to be delivered, and asks the user to confirm the message sending. If the user confirms, the system modifies the electronic message that is sent to each recipient so as to include their name in the electronic message (that is, the system does a mail-merge operation). The system also modifies the electronic message sent to each recipient so that the reply address to which returned electronic message notifications will be sent is a special electronic-mail address at which the system itself is listening. The reply address is also encoded specially in each recipient's version of the electronic message so that the returned electronic message will contain enough information to uniquely identify which customer's electronic message was returned.

The electronic message is then delivered to the individual customers using the bulk message delivery system (6) described below.

Data Replication System (5)

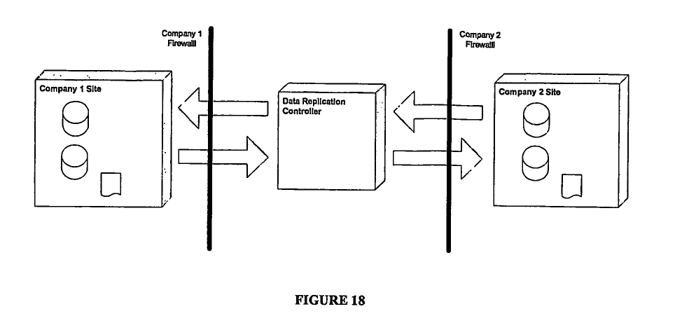

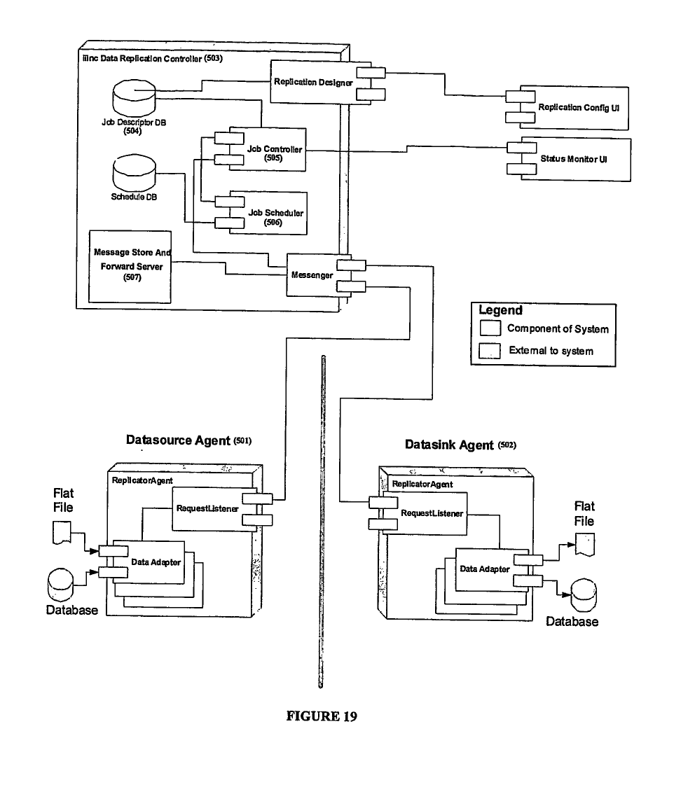

In one embodiment of the present invention, this system is used to allow the transfer of customer contact lists from a remote external location to the server that hosts the customer database (401). The external location may be the message-sending company (10) or one or more other sites that provide this information. In another embodiment of the present invention, this system can be used to transfer electronic messages from the messaging controller site (11) to the message-sending company (10) as part of the bulk message delivery system (6) described below. In yet another embodiment of the present invention, this system may be used to transfer any information between sites within the same organization. In any of these data transfers, in one embodiment the system can apply simple format transformations to the data as it is being transferred from one database to the other. An example where this embodiment is useful is when working around incompatibilities such as data format incompatibilities, between for example, different departments' customer lists. In a further embodiment of the present invention, this system may be used to transfer any information between any two mutually remote computing sites, each of which is protected from arbitrary Internet data access by firewall hardware and/or software. This functionality is schematically illustrated in FIG. 18. This data replication system illustrated in FIG. 19, comprises two replication agents, one configured as a data source agent (501) and one as a data sink agent (502).

Each replication agent in the pair communicates with the other agent in the pair that is hosted on a different computer within a different secure company intranet behind a firewall. Communication occurs via the intermediary message store-and-forward server (507), which is part of the data replication controller (503), using a communication protocol that enables either agent to initiate communication and data transfer to the other agent, despite the dual firewall protection that separates the two agents in the pair. The communication protocol does not require reconfiguration of the firewall at either end to facilitate this bi-directionally initiated data communication. The protocol is able to communicate through firewalls by having each agent in the communicating pair periodically poll the intermediary message store-and-forward server (507), which is not behind any firewall that would restrict the receipt or reply of the polling messages. The polling messages get through the firewall surrounding the polling agent because the poll message is the equivalent of a standard port-80 http client request to an external web server, and firewalls are typically configured to allow such traffic through unhindered. The poll message checks for messages destined for the agent. If a message for the agent is waiting on the message store-and-forward server (507), it is sent to the agent as the reply to the poll message, or a reference to the message is sent as the reply to the poll message and the agent makes a second standard-port http (or https) request to the store-and-forward server (507) to download the message. Each agent must be configured by a representative of the organization that hosts it in order to allow only particular, constrained subsets of information, specified by particular SQL queries, to be communicated to the other agent. The parameters specified during configuration can include the web service address of the central message-store-and-forward server (507) with which the agent will communicate, the names and/or addresses/URLs of databases that the agent is to query or update, and user accounts and passwords for access to the databases, for example.

The data replication controller (503) also includes software that facilitates the creation of a replication specification, which specifies the data source (501) and data sink agent (502)), the data access query to be executed by the data source agent (501), and the data store or update (query to he executed by the data sink agent (502). A data query command is a command to be executed by one agent to retrieve data from one or more databases or files located on the local computing network where the agent is installed. A data update or data Store command is a command to be executed by the other agent to store the data from the first agent in a database or rile located in the local computing environment where the second agent is installed. The user who is logged into the data replication controller application user interface can specify any number of “replication task specifications”. These specifications as well as their associations with particular pairs of replication agents are stored in a database (504) within the data replication controller. A further job controller (505) within the data replication controller (503) invokes, co-ordinates, and monitors the status of data replication jobs. In addition, the data replication controller includes a replication jobs scheduler (506), which accepts and stores scheduling specifications of data replication tasks, and places replication jobs onto a job queue with in indication of the time at the which the replication job should be initiated.

When activated, each agent begins polling periodically the message store-and-forward server (507), and if messages are available for the agent, the agent downloads the message and acts on the command present in the message. The command may be a data query, which comprises either an SQL query and database identifier, or a path specification of a data file, for example. Execution of the data query comprises querying the database, or reading the data file, and transferring the resulting data to the message store-and-forward server (507) where the data will be stored. When the message store-and-forward server (507) receives data from a data query, it stores the data and notifies the replication controller (503) that the data is available. The replication controller (503) then communicates to the store-and-forward server (507) and places a “take available data” message addressed to the recipient agent (502) into the message store-and-forward server (507).

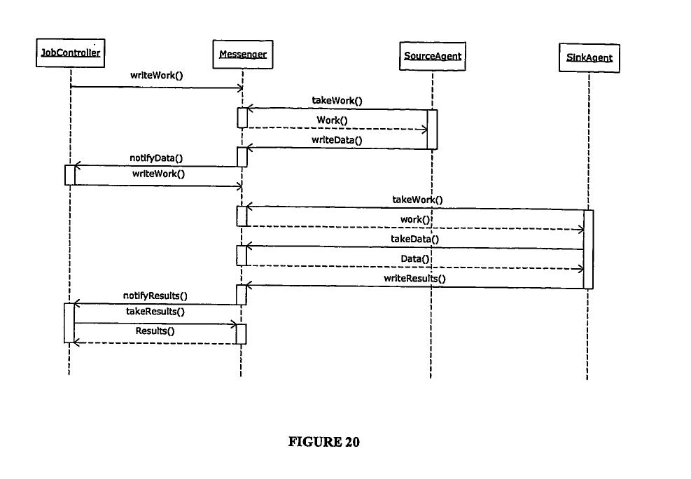

The next time that the recipient agent polls the message-store-and-forward server (507), it is notified that there is data available for it. The agent (502) downloads the data from the server and then executes the accompanying command, which, based on the data replication specification, will be an “update data”, “plate data safely” or “store data file” command. In the case of an “update data” command, the agent (502) inserts the data rows into a specified local database via an SQL client/server connection to the database server, if the rows do not already exist in the database. If the rows exist, they are updated from the newly arrived data. An “update data safely” command operates the same, except that any rows that already exist in the database are inserted in a special “conflicting updates” table in the database rather than being updated directly in the final target data table. This allows a local application or user to update the actual table more carefully based on an inspection of the corresponding rows of the “conflicting updates” table and actual data table. A “store data” command comes with a file pathname and the agent writes the data to a file with that pathname. A sequence diagram for the data replication system (5) is shown in FIG. 20.

Bulk Message Delivery System (6)

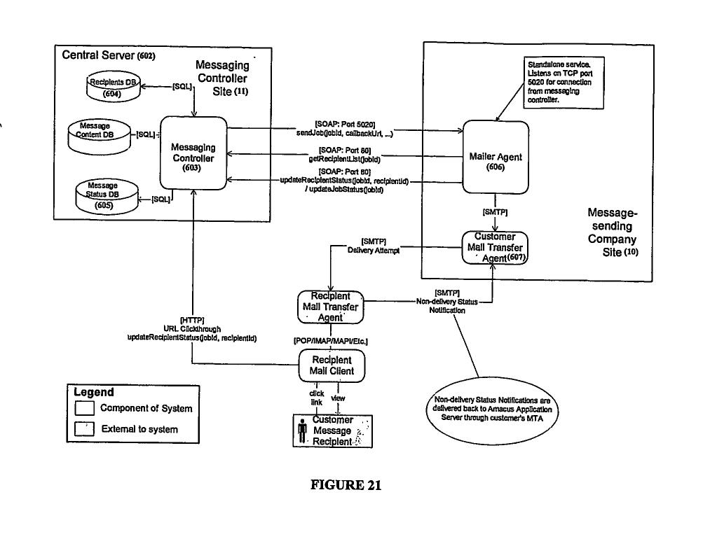

The purpose of this system, illustrated in FIG. 21 is to control the delivery of electronic messages to a large set of recipients. It comprises two collaborating distributed components: (i) a central server component (602), located at the messaging controller site, including a process-controller software component (603), a recipient database (604) and electronic message communication status database, and (ii) a mailer-agent component (606), to be located at each message-sending company's site.

Prior to sending the electronic message to the recipients, the central server (602) modifies any interaction points, for example hyperlinks, included in the electronic message to ensure that all interaction points are traceable by the tracking system (7) described below. When for example a hyperlink refers to a content item that is large in size such as a multimedia content item, the system may also configure the hyperlink to trigger an action that detects the recipient's internet connection bandwidth upon their clicking on the hyperlink. If a low bandwidth is detected and a low-bandwidth content item (that is, an item that will download quickly because it is small in data size) is available as a designated alternate to a high-bandwidth multimedia content item, then the low-bandwidth content item is displayed to the user instead of the multimedia content item.

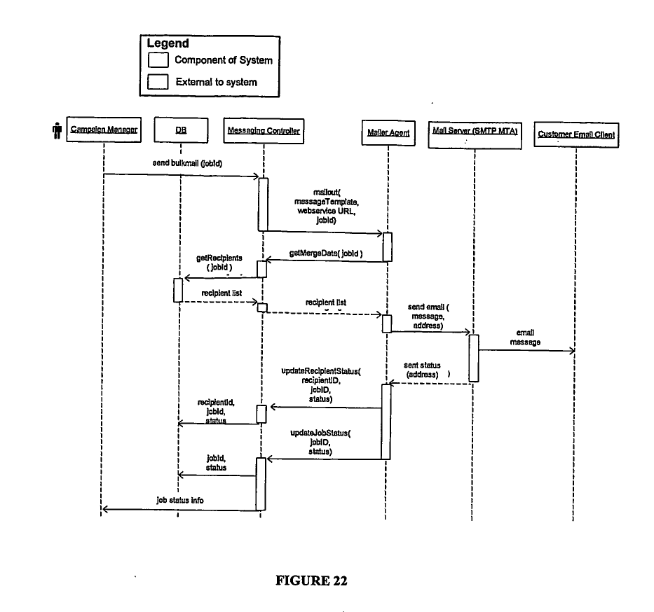

The central server component communicates via the Simple Object Access Protocol (SOAP protocol) or a protocol of similar functionality, with the mailer agent, to initiate a bulk message sending process. Upon this initialization, the mailer agent communicates back to the central server via SOAP protocol to obtain the list of recipient names and electronic mail addresses. The mailer agent then sends the addressed electronic messages to the message-sending company's internal electronic mail server known as the message transfer agent (607) via SMTP protocol or a protocol of similar functionality. As mentioned previously, in another embodiment of the present invention, the data replication system (5) may be used to transfer electronic messages from the messaging controller site to the message-sending company, where the electronic messages are forwarded to the message transfer agent (607). The electronic messages are thus sent out to all of the recipients. A sequence diagram for the bulk message delivery system (6) is shown in FIG. 22.

All returned electronic messages are analysed and information is displayed to the sender of the electronic message indicating which customers had returned electronic messages, and whether the return was caused by an invalid or non-existent electronic mail address, or was caused by some other possibly transient electronic messaging failure. The system gives the user the opportunity to correct the electronic mail addresses of returned customer records, or to delete those records from the customer record database.

The distributed architecture of this subsystem can allow organization and administration of the bulk messaging campaign to take place on a single, special purpose central server, which provides application service provider (ASP) style web user interfaces to its functions, while the actual electronic messages sent as part of the messaging campaign are sent via each sending-company's own mail server, mediated by the remote mailer agent. This distribution of messaging system responsibilities results in the electronic messages having an appropriate sending-company mail server as their originating electronic mail server, even though an outsourced ASP messaging campaign management process is used to co-ordinate the mailing campaign. The distributed architecture can also yield the desirable property of freeing its own resources by offloading the sending of the individual electronic messages to the sending-company's host computer without overburdening it with the central server component of the messaging system.

Messaging Campaign Tracking and Assessment System (7)

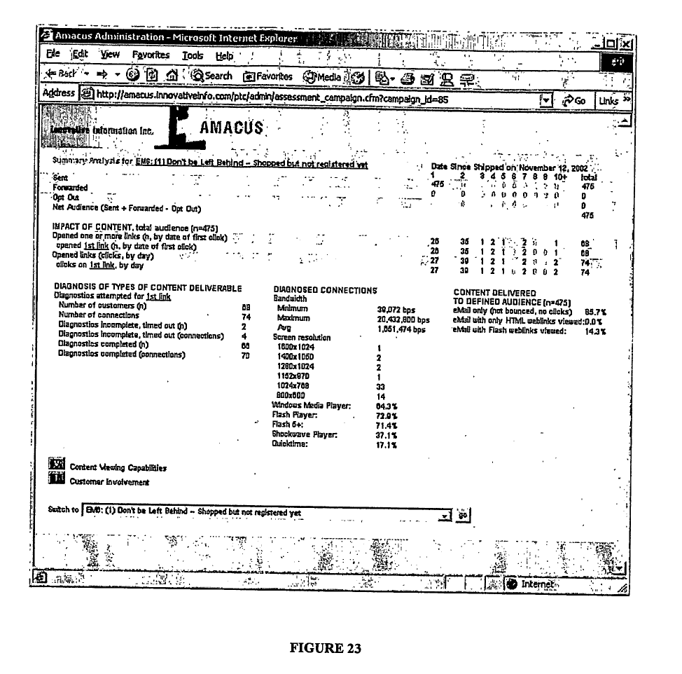

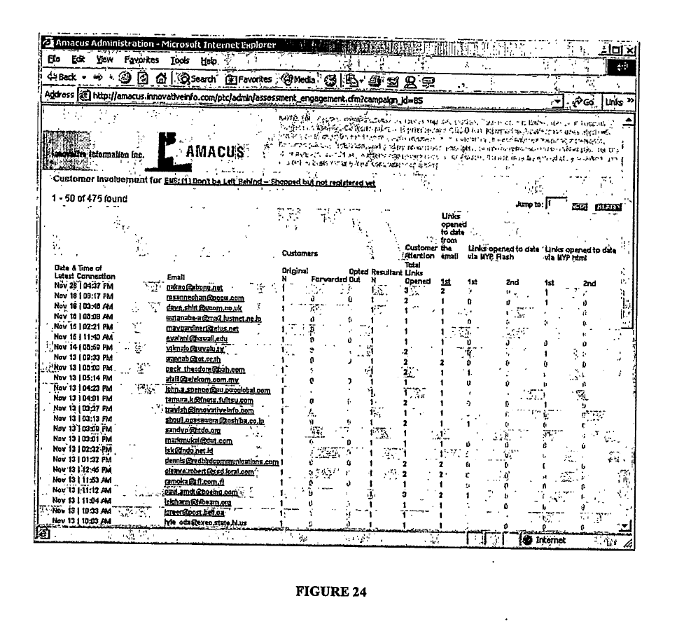

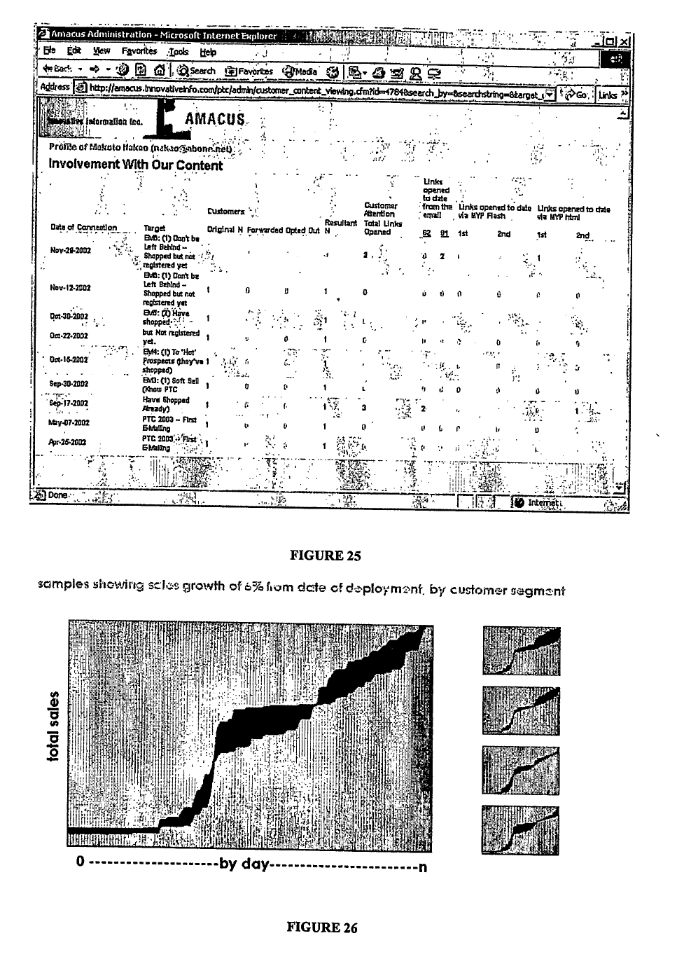

This system tracks the interaction of customers with the electronic messages sent to them as well as providing a means for assessment of the effectiveness of the various messaging campaigns. The system also allows assessment of the disposition of customers towards propositions in a series of electronic messages sent to them, and their likelihood to act on future electronic messages sent to them. When a recipient clicks on an interaction point in the electronic message received, it triggers an action of the system that records which recipient clicked on which interaction point and when. This information is stored in a database and used to obtain insight into campaign message effectiveness and content/topic popularity. As mentioned previously, the targeting system (4) modifies the interaction points to ensure they trigger the recording action when clicked upon. For example, the tracking system (7) can produce a summary of the number of clicks (and successful page openings) on each URL in the electronic message for viewing by the user as shown in FIG. 23. The system can also display a detailed report of interactions with content for each customer included in the campaign message audience as shown in FIG. 24. The interactions of individual customers with URL content from different campaigns can also be viewed as shown in FIG. 25. In addition, the system can produce graphical displays of the cumulative number of customer conversion transactions per day, compared to the cumulative number of such transactions in a reference baseline, which may be a particular previous messaging campaign or an average of the results of several previous campaigns. These graphs can be for a particular messaging campaign or a specific audience-type as shown in FIG. 26. This allows fine-grained analysis of the relative response rate of customers of various types to the campaign.

In another embodiment of the present invention, the messaging campaign tracking and assessment system, in combination with the audience targeting system (4) is able to automatically categorize customers into further pre-existing audience-type categories or remove them from existing audience-type categories. This further categorization uses a set of rules based on logical combinations of a customer's attributes and/or patterns of customer interaction with particular content in a series of electronic messages sent to them, and can be defined by the message-sending company. Examples of these rules include rules based on whether a particular customer clicked on a particular interaction point or failed to click on a particular interaction point after a specified time, or based on whether new customer information was added to the customer database (401). The audience-type categories can also identify, for example certain communication approaches or certain topics in which a customer would be interested. For example, audience-types that could be assigned to automatically populated categories, include “aware of X”, “interested in X”, “deciding whether to act on X”, “committed to acting on X”. These further categorized customers can then receive electronic messages the next time a campaign manager selects their audience-type category to send an electronic message to. In addition, electronic messages can automatically be sent to customers that newly join a given audience-type category.

This embodiment of the messaging campaign tracking and assessment system can also be able to record the history of customers into and out of these automatically populated audience-type categories, as well as how long the customers were part of each category.

This can allow for the assessment of the evolution of the disposition of customers towards certain topics or suggestions, for example.

Health and Performance Monitoring System (8)

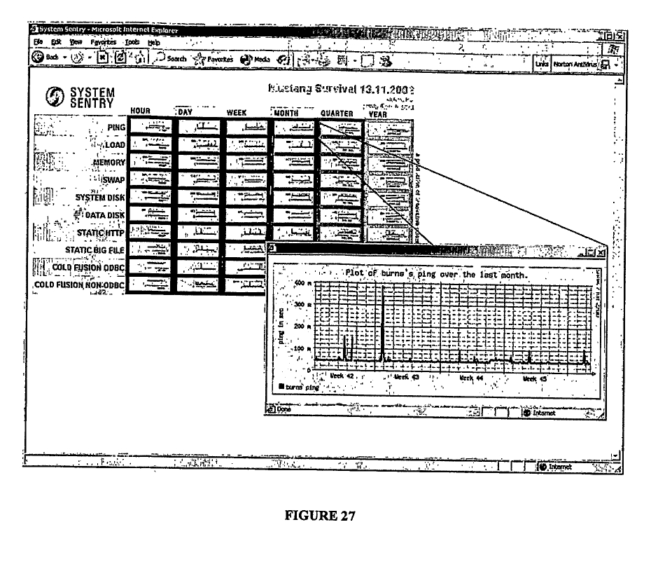

In one embodiment, a monitoring agent is placed on each computer that hosts parts of the distributed system. This agent can monitor system performance, communication performance, and system and application health parameters of the computer. Health refers to the malfunctioning of components or communications. Performance measures include parameters such as the interactive response speed of a user interface, the speed of delivering electronic messages, timeliness of notification deliveries, and speed of communication between various components of the whole system and other parameters. The user interface of this system is shown in FIG. 27. This system sends a regular stream of performance and health data back to a central monitoring server, located at the messaging controller site, which can produce time-series graphs of the system parameters of each host computer, and can also immediately notify a human system operator, via electronic mail or other means, if any host computer that is part of the distributed system is non-functional or unhealthy in some sense. This rapid notification of non-functional components facilitates the rapid repair of system problems and therefore facilitates a high system availability and reliability level.

We claim:

1. A distributed electronic marketing, sales and service management system enabling the creation, distribution and tracking of at least one electronic message to at least one predetermined potential customer, said system comprising:
a) a data storage system for organizing and storing a plurality of content, selected portions of said content for insertion into the at least one electronic message;
b) a production system for the creation of the at least one electronic message, said at least one electronic message having a predetermined theme, wherein content having the predetermined theme can be inserted into the at least one electronic message;
c) a messaging system performing functions including transmission of the at least one electronic message to the at least one predetermined potential customer, said messaging system and the at least one predetermined customer being interconnected by at least one communication network;
d) a tracking system for collecting and evaluating notifications based on interaction width the at least one electronic message by the at least one predetermined potential customer;
wherein the data storage system, production system, messaging system and tracking system are electronically interconnected thereby enabling electronic information transfer therebetween.

2. The distributed electronic marketing, sales and service management system according to claim 1, wherein the plurality of content within the data storage system can be associated with one or more descriptors, wherein the data storage system can be searched for content having predetermined descriptors.

3. The distributed electronic marketing, sales and service management system according to claim 1, wherein the production system provides a means for separating a previously created electronic message into component pieces, said production system further providing a means for replacing selected component pieces with content selected from the data storage system.

4. The distributed electronic marketing, sales and service management system according to claim 1, wherein the production system provides a means for separating a multimedia content item into component pieces and creating a semantic outline thereof, said production system further providing a means for presenting the semantic outline alongside the multimedia content item, said production system providing a means for modification of the multimedia content item through replacement of component pleces with alternate content selected from the data storage system producing an amended multimedia content item, said production system thereby enabling viewing of the amended multimedia content item simultaneously with the semantic outline for ease of amendment.

5. The distributed electronic marketing, sales and service management system according to claim 1, further comprising a targeting system providing a means for selecting the at least one predetermined customer or group of predetermined customers, wherein said selection can be made based on a predetermined criteria wherein the at least one predetermined customer or group of predetermined customers are associated with the predetermined criteria.

6. The distributed electronic marketing, sales and service management system according to claim 5, wherein said predetermined criteria provides a means for the targeting system to organise a plurality of customers into categories, wherein the at least one predetermined customer or group of predetermined customers can be assigned one or more categories based on notifications received by the tracking system.

7. The distributed electronic marketing, sales and service management system according to claim 1, wherein the messaging system includes a means for modifying a generic electronic message in order to personalize the generic electronic message for a selected predetermined potential customer, said modification providing a means for the tracking system to correlate notifications with the selected predetermined potential customer.

8. The distributed electronic marketing, sales and service management system according to claim 7, wherein the messaging system includes a means for electronically transmitting the at least one electronic message to an intermediate host, said intermediate host subsequently transmitting the at least one electronic message to the at least one predetermined customer, and said intermediate host being identified to the at least one predetermined customer as originator of the transmission of the at least one electronic message.

9. The distributed electronic marketing, sales and service management system according to claim 1, further comprising a monitoring system for evaluating the functionality of the distributed electronic management system, said monitoring system providing a means for transmission of an alarm to a system manager upon detection of a potential problem.

10. The distributed electronic marketing, sales and service management system according to claim 1, further comprising a means for transmitting correspondence to a sales representative, said correspondence resulting from notifications received by the tracking system, said correspondence transmitted to the sales representative upon receipt of signal from the tracking system, thereby providing a means for the sales representative to timely respond to a request from the at least one predetermined customer.

11. The distributed electronic marketing, sales and service management system according to claim 10, wherein the correspondence is a SMS or cellular telephone call.

12. The distributed electronic marketing, sales and service management system according to claim 1, further comprising a data replication system enabling data transfers from a first database to a second database, wherein the first and second databases are each protected by a firewall type system.

13. A method for the creation, distribution and tracking of at least one electronic message to at least one predetermined potential customer, said method comprising the steps of:
a) organizing and storing a plurality of content, selected portions of said content for insertion into the at least one electronic message;
b) creating the at least one electronic message, said at least one electronic message having a predetermined theme, wherein content having the predetermined theme can be inserted into the at least one electronic message;
c) transmitting the at least one electronic message to the at least one predetermined potential customer;
d) collecting and evaluating notifications based on interaction with the at least one electronic message by the at least one predetermined potential customer;
wherein the collection and evaluation of the notifications enables incorporation of content relating to these previous notifications into a subsequently created and transmitted electronic message to the same predetermined potential customer.

14. The method according to claim 13, wherein prior to the step of organizing and storing the plurality of content each piece of content of the plurality of content can have at least one descriptor associated therewith thereby providing a means for organizing the plurality of content.

15. The method affording to claim 13, wherein the step of creating the at least one electronic message includes inserting at least one interaction point into the at least one electronic message, said interaction point including a means for transmitting notifications to a tracking system.

16. The method according to claim 13, wherein the step of collecting and evaluating notifications provides a means for determining a theme for an electronic message subsequently transmitted to the same at least one potential customer.

17. A computer program product comprising a computer readable medium having a computer program recorded thereon for performing a method for the creation, distribution and tracking of at least one electronic message to at least one predetermined potential customer comprising the steps of:
a) organizing and storing a plurality of content, selected portions of said content for insertion into the at least one electronic message;
b) creating the at least one electronic message, said at least one electronic message having a predetermined theme, wherein content having the predetermined theme can be inserted into the at least one electronic message;
c) transmitting the at least one electronic message to the at least one predetermined potential customer;
d) collecting and evaluating notifications based on interaction with the at least one electronic message by the at least one predetermined potential customer;
wherein the collection and evaluation of the notifications enables incorporation of content relating to these previous notifications into a subsequently created and transmitted electronic message to the same predetermined potential customer.
